(19) United States
(12) Patent Application Publication
(10) Pub. No.: US 2026/0229070 A1
(43) Pub. Date: Aug. 6, 2026

(54) CONTROL DEVICE, CONTROL METHOD, AND RECORDING MEDIUM

(71) Applicant: Sony Honda Mobility Inc., Tokyo (JP)

(72) Inventors: Ryu Tate, Tokyo (JP); Yasuhisa Ito, Tokyo (JP)

(73) Assignee: Sony Honda Mobility Inc., Tokyo (JP)

(21) Appl. No.: 19/043,817

(22) Filed: Feb. 3, 2025

(51) Int. Cl. G07C 5/02; G07C 5/00

(52) U.S. Cl. CPC G07C 5/02; G07C 5/008

(57) ABSTRACT

A control device, a control method, and a recording medium for enabling an immersive feeling during driving to be produced are provided. A control device (100) includes a processor. The processor executes a program to acquire a detection result of a vehicle sensor group (40) that detects at least one of a driving situation of a vehicle and behavior of the vehicle and cause a vibration device (VD1 or VD2) mounted on a steering wheel (SW) of the vehicle to generate vibrations corresponding to at least one of the driving situation of the vehicle and the behavior of the vehicle in accordance with the acquired detection result.

### BACKGROUND OF THE INVENTION

### Field of the Invention

The present disclosure relates to a control device, a control method, and a recording medium.

### Description of Related Art

Conventionally, technology for transmitting various types of information to an occupant of a vehicle by vibrating a vibration device mounted on the vehicle is known. For example, the following Patent Document 1 discloses technology for improving fuel efficiency by providing a vibration device on a pedal and vibrating the vibration device to change a manipulation situation of the pedal. Moreover, the following Patent Document 2 discloses technology for prompting an occupant of a vehicle to perform a shift manipulation by providing a vibration device on a steering wheel of the vehicle and vibrating the vibration device at a timing when the shift manipulation should be performed.

### Patent Documents

[Patent Document 1] U.S. Pat. No. 8,290,697

[Patent Document 2] U.S. Pat. No. 9,188,223

### SUMMARY OF THE INVENTION

Meanwhile, a shift from gasoline vehicles to electric vehicles (EVs) is currently underway to reduce greenhouse gases. Compared to gasoline vehicles, in EVs, information during movement tends to be lacking, such that an immersive feeling during driving deteriorates. For this reason, the EV is required to produce an immersive feeling during driving by feeding back information corresponding to a driving situation of a vehicle or the behavior of the vehicle to an occupant during movement.

The present disclosure has been made in view of the above-described circumstances and an objective of the present disclosure is to provide a control device, a control method, and a recording medium for enabling an immersive feeling during driving to be produced.

To solve the above-described problems, according to a first aspect of the present disclosure, there is provided a control device (100 or 100A) for controlling vibrations generated by a vibration device (VD1 or VD2) mounted on a driving manipulation element (SW) of a vehicle (M), the control device including: a processor, wherein the processor executes a program to acquire a detection result of a detection sensor that detects at least one of a driving situation of the vehicle and behavior of the vehicle, and cause the vibration device to generate vibrations corresponding to at least one of the driving situation of the vehicle and the behavior of the vehicle in accordance with the acquired detection result.

According to a second aspect of the present disclosure, in the control device according to the first aspect, the processor may generate the vibrations corresponding to at least one of the driving situation of the vehicle and the behavior of the vehicle on the basis of the acquired detection result.

According to a third aspect of the present disclosure, in the control device according to the first or second aspect, the processor may select definition information for defining the vibrations corresponding to at least one of the driving situation of the vehicle and the behavior of the vehicle from definition information for defining a plurality of vibrations provided in advance on the basis of the acquired detection result, and cause the vibration device to generate the vibrations based on the selected definition information.

According to a fourth aspect of the present disclosure, in the control device according to any one of the first to third aspects, the processor may transmit the acquired detection result to a server device, receive definition information for defining the vibrations corresponding to at least one of the driving situation of the vehicle and the behavior of the vehicle transmitted from the server device in accordance with the detection result transmitted to the server device, and cause the vibration device to generate the vibrations based on the received definition information.

According to a fifth aspect of the present disclosure, in the control device according to any one of the first to fourth aspects, the processor may perform control so that a vibration intensity of the vibration device gradually increases or decreases within a prespecified transition period at a start or end of the vibrations of the vibration device.

According to a sixth aspect of the present disclosure, in the control device according to any one of the first to fifth aspects, the processor may acquire a detection result of a detection sensor that detects an accelerator opening degree of the vehicle, and cause the vibration device to generate the vibrations corresponding to a manipulation situation of an accelerator pedal on the basis of the acquired detection result.

According to a seventh aspect of the present disclosure, in the control device according to any one of the first to sixth aspects, the processor may acquire a detection result of a detection sensor that detects at least one of acceleration of the vehicle in a longitudinal direction and acceleration of the vehicle in a lateral direction, and cause the vibration device to generate the vibrations corresponding to the behavior of the vehicle on the basis of the acquired detection result.

According to an eighth aspect of the present disclosure, in the control device according to any one of the first to seventh aspects, the processor may acquire a detection result of a detection sensor that detects a speed of the vehicle, and cause the vibration device to generate the vibrations corresponding to the speed of the vehicle on the basis of the acquired detection result.

According to an aspect of the present disclosure, there is provided a control method for controlling vibrations generated by a vibration device (VD1 or VD2) mounted on a driving manipulation element (SW) of a vehicle (M), the control method including: acquiring, by a computer, a detection result of a detection sensor (40) that detects at least one of a driving situation of the vehicle and behavior of the vehicle (S11), and causing, by the computer, the vibration device to generate vibrations corresponding to at least one of the driving situation of the vehicle and the behavior of the vehicle in accordance with the acquired detection result (S14).

According to an aspect of the present disclosure, there is provided a computer-readable non-transitory recording medium recording a program for causing a computer to acquire a detection result of a detection sensor (40) that detects at least one of a driving situation of a vehicle (M) and behavior of the vehicle (S11), and cause a vibration device mounted on a driving manipulation element of the vehicle to generate vibrations corresponding to at least one of the driving situation of the vehicle and the behavior of the vehicle in accordance with the acquired detection result (S14).

According to the present disclosure, a special operation effect of producing an immersive feeling during driving can be obtained.

### BRIEF DESCRIPTION OF THE DRAWINGS

FIG. 1 is a diagram schematically showing the interior of a cabin of a vehicle according to a first embodiment of the present disclosure.

FIG. 2 is a block diagram showing an exemplary configuration of a vehicle control system including a control device according to the first embodiment of the present disclosure.

FIG. 3 is a block showing an internal configuration of a generation unit according to the first embodiment of the present disclosure.

FIG. 4 is a diagram showing an example of a signal waveform generated by the generation unit in the first embodiment of the present disclosure.

FIG. 5 is an explanatory diagram of the control of a vibration device in the first embodiment of the present disclosure.

FIG. 6 is a flowchart showing an example of a control method according to the first embodiment of the present disclosure.

FIG. 7 is an explanatory diagram of an example in which an accelerator response feeling is produced in the first embodiment of the present invention.

FIG. 8 is an explanatory diagram of an example in which a traction feeling is produced in the first embodiment of the present invention.

FIG. 9 an explanatory diagram of an example in which a speed feeling is produced in the first embodiment of the present invention.

FIG. 10 is a block diagram showing a key configuration of a control device according to a second embodiment of the present disclosure.

### DETAILED DESCRIPTION OF THE INVENTION

Hereinafter, a control device, a control method, and a recording medium according to the embodiment of the present disclosure will be described in detail with reference to the drawings.

### First Embodiment

### <Vehicle>

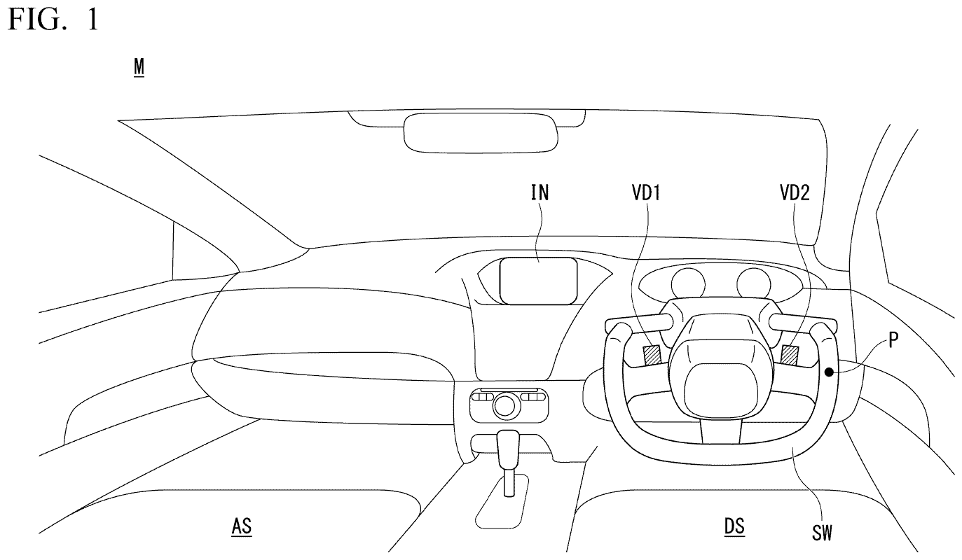

FIG. 1 is a diagram schematically showing the interior of a cabin of a vehicle according to a first embodiment of the present disclosure. As shown in FIG. 1, a vehicle M includes an instrument panel IN, a driver's seat DS, a passenger seat AS, a steering wheel SW, and the like in the vehicle cabin. The vehicle M is, for example, a vehicle such as a two-, three-, or four-wheeled vehicle, and its drive source is an internal combustion engine such as a diesel engine or a gasoline engine, an electric motor, or a combination thereof. In the present embodiment, the vehicle M will be described with reference to an example of a four-wheeled vehicle (EV) having an electric motor as a drive source.

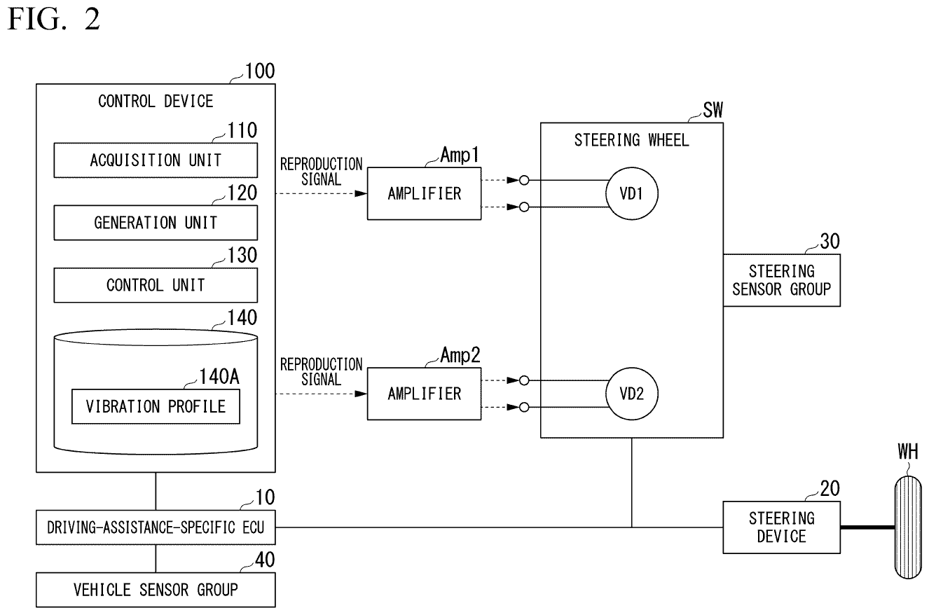

The steering wheel SW is a driving manipulation element that is manipulated by a driver of the vehicle M. A sensor that detects a manipulation amount or the presence or absence of a manipulation is attached to the steering wheel SW and its detection result is output to a driving-assistance-specific support electronic control unit (ECU) 10 and a steering device 20 (see FIG. 2). The steering wheel SW does not necessarily have to be annular, and may be an irregular steering wheel.

Moreover, the steering wheel SW is equipped with vibration devices VD1 and VD2 on the left and right sides of the steering wheel SW. The vibration devices VD1 and VD2 each have a built-in motor and generate vibrations on the steering wheel SW by operating the motor in response to a reproduction signal output from a control device 100 (see FIG. 2). The motors built into the vibration devices VD1 and VD2 may be direct-acting motors (for example, voice coil motors) or rotary motors (for example, direct current (DC) motors).

The vibration device VD1 is installed on the left side of the steering wheel SW and is used to transmit vibrations to the left hand of the driver who grips the steering wheel SW. The vibration device VD2 is installed on the right side of the steering wheel SW and is used to transmit vibrations to the right hand of the driver who grips the steering wheel SW.

### <Vehicle Control System>

FIG. 2 is a block diagram showing an exemplary configuration of a vehicle control system including a control device according to the first embodiment of the present disclosure. As shown in FIG. 2, the control system of the vehicle M includes the driving-assistance-specific ECU 10, the steering device 20, a steering sensor group 30, a vehicle sensor group 40 (a detection sensor), amplifiers Amp1 and Amp2, and a control device 100.

The driving-assistance-specific ECU 10 executes an advanced driver assistance system (ADAS) for the driver on the basis of a detection result of the vehicle sensor group 40. The ADAS includes, for example, a lane departure warning (LDW) that warns of the departure of the vehicle M from a travel lane. As an example, the driving-assistance-specific ECU 10 executes the ADAS by generating vibrations from the vibration devices VD1 and VD2 via the control device 100.

The steering device 20 includes, for example, a steering ECU and an electric motor. The steering ECU drives the electric motor according to information output from the driving-assistance-specific ECU 10 or information output from the steering wheel SW and causes the direction of the steering wheel to change. The electric motor, for example, acts a force on a rack and pinion mechanism to change the direction of the steering wheel.

The steering sensor group 30 is a sensor group attached to the steering wheel SW. The steering sensor group 30 includes, for example, a steering grip sensor and a vibration displacement sensor. The steering grip sensor is implemented by a capacitive sensor or the like and outputs a signal for detecting whether or not the driver is gripping the steering wheel SW (indicating that it is in contact with the steering wheel SW in a state in which a force is applied) to the driving-assistance-specific ECU 10. The vibration displacement sensor measures the displacement [cm] of the vibrations generated at each position (point) of the steering wheel SW as the vibration intensity and outputs the measured vibration intensity to the control device 100. Furthermore, the vibration intensity measured by the vibration displacement sensor may be directly output to the control device 100 without going through the driving-assistance-specific ECU 10.

The vehicle sensor group 40 includes a sensor indicating a surrounding situation of the vehicle M, a sensor indicating a driving situation of the vehicle M, and a sensor indicating the behavior of the vehicle M. The sensor indicating the surrounding situation of the vehicle M includes an image sensor, an outside air temperature sensor, and the like installed to image the surrounding situation of the vehicle M. The sensor indicating the driving situation of the vehicle M includes an accelerator position sensor that detects an accelerator opening degree. The sensor indicating the behavior of the vehicle M includes a vehicle speed sensor that detects the speed of the vehicle M, an acceleration sensor that detects acceleration, a yaw rate sensor that detects an angular velocity around a vertical axis, a direction sensor that detects a direction of the vehicle M, and the like.

Furthermore, as the image sensor, for example, a solid-state image sensor such as a charge-coupled device (CCD) or a complementary metal oxide semiconductor (CMOS) can be used. The acceleration sensor is preferably capable of detecting acceleration of the vehicle in a longitudinal direction and acceleration of the vehicle in a lateral direction. In the acceleration sensor, a sensor that detects acceleration of the vehicle in the longitudinal direction and a sensor that detects acceleration of the vehicle in the lateral direction may be integrated or separate. Furthermore, as the acceleration sensor, only a sensor that detects acceleration of the vehicle in the longitudinal direction may be provided or only a sensor that detects acceleration of the vehicle in the lateral direction may be provided.

The amplifiers Amp1 and Amp2 amplify a reproduction signal output from the control device 100, respectively. The amplifier Amp1 outputs the amplified reproduction signal to the vibration device VD1 and the amplifier Amp2 outputs the amplified reproduced signal to the vibration device VD2. The amplifiers Amp1 and Amp2 are connected to the vibration devices VD1 and VD2, respectively, via a cable reel.

### <Control Device>

The control device 100 includes, for example, an acquisition unit 110, a generation unit 120, a control unit 130, and a storage unit 140. The acquisition unit 110 acquires detection results of various types of sensors provided in the vehicle sensor group 40. The acquisition unit 110 outputs the acquired detection results to the generation unit 120 and the control unit 130 as detection data. Furthermore, the detection data may be stored in the storage unit 140.

The generation unit 120 generates a vibration profile that is definition information for defining the vibrations (more specifically, vibration intensities, frequency and phases) of the vibration devices VD1 and VD2 in accordance with the detection results acquired by the acquisition unit 110. The vibration profile generated by the generation unit 120 is used to produce an immersive feeling when the driver is driving the vehicle.

The generation unit 120 generates a vibration profile that defines vibrations corresponding to the driving situation of the vehicle M in accordance with the detection result of the sensor indicating the driving situation of the vehicle M provided in the vehicle sensor group 40. For example, the generation unit 120 generates a vibration profile that defines vibrations for producing a response feeling (an accelerator response feeling) of acceleration or deceleration of the vehicle M by manipulating the accelerator pedal in accordance with a detection result (an accelerator opening degree) of the accelerator position sensor provided in the vehicle sensor group 40. Furthermore, in addition to the detection result of the accelerator position sensor described above, a vibration profile may be generated by taking into account the detection result of the acceleration sensor (a sensor that detects acceleration of the vehicle in the lateral direction).

The generation unit 120 generates a vibration profile that defines vibrations corresponding to the behavior of the vehicle M in accordance with the detection result of the sensor indicating the behavior of the vehicle M provided in the vehicle sensor group 40. For example, the generation unit 120 generates a vibration profile that defines vibrations for producing a traction force (a traction feeling) due to a grip force of the tire during acceleration or deceleration or in a turning state in accordance with the detection result of the acceleration sensor provided in the vehicle sensor group 40. Alternatively, the generation unit 120 generates a vibration profile that defines vibrations for producing a speed feeling corresponding to a contact situation between the tire and the road surface in a high-speed range in accordance with the detection result of the vehicle speed sensor provided in the vehicle sensor group 40.

The control unit 130 vibrates the vibration devices VD1 and VD2 in accordance with the vibration profile generated by the generation unit 120 or a vibration profile 140A stored in the storage unit 140. For example, when the vibration devices VD1 and VD2 are vibrated, the control unit 130 may change vibration intensities and phases of the vibration devices VD1 and VD2 in consideration of a positional relationship of the vibration devices VD1 and VD2 and a predetermined point P (see FIG. 1). Furthermore, in the present embodiment, the predetermined point P is a position on the steering wheel SW that is generally assumed to be most frequently gripped by the driver of the vehicle M during driving and is decided in advance.

For example, when the predetermined point P is located on the right side of the steering wheel SW, the vibrations of the vibration device VD1 can be prevented from propagating to the predetermined point P by changing the vibration intensity and phase of the vibration device VD1. Likewise, for example, when the predetermined point P is located on the left side of the steering wheel SW, the vibration intensity and phase of the vibration device VD1 can be changed to prevent the vibrations of the vibration device VD2 from propagating to the predetermined point P. As a result, the driver can more clearly feel the vibrations on the left side of the steering wheel SW.

The storage unit 140 stores, for example, the vibration profile 140A, various types of parameters necessary for the generation unit 120 to generate the vibration profile, and the like. The vibration profile 140A is definition information for defining the vibrations (more specifically, the vibration intensities, frequency and phases) of the vibration devices VD1 and VD2. The vibration profile 140A is similar to the vibration profile generated by the generation unit 120, except that the vibration profile 140A is generated in advance and stored in the storage unit 140. That is, the vibration profile 140A includes, for example, a plurality of vibration profiles that define vibrations for producing the above-described accelerator response feeling, traction feeling, and speed feeling and the like. When the vibration profile 140A stored in the storage unit 140 is used, the control unit 130 selects and uses a vibration profile corresponding to the driving situation of the vehicle M or the behavior of the vehicle M from the vibration profile 140A.

The acquisition unit 110, the generation unit 120, and the control unit 130 are implemented by, for example, a hardware processor such as a central processing unit (CPU) executing a program (software). Moreover, some or all of these constituent elements may be implemented by hardware (including a circuit unit; circuitry) such as a large-scale integration (LSI) circuit, an application-specific integrated circuit (ASIC), a field-programmable gate array (FPGA), a graphics processing unit (GPU), and a system on chip (SOC) or may be implemented by software and hardware in cooperation.

The program may be stored in a storage device such as a hard disk drive (HDD) or flash memory (a storage device including a non-transitory storage medium) of the control device 100 in advance. Alternatively, the program may be stored in a removable recording medium such as a DVD or CD-ROM and installed in the HDD or flash memory of the control device 100 when the recording medium (non-transitory recording medium) is mounted on a drive device.

The storage unit 140 is implemented by a storage device such as an HDD, a flash memory, or a random-access memory (RAM). The storage unit 140 may be fixed to the control device 100 or may be detachably provided on the control device 100.

### <Vibration Profile Generation Method>

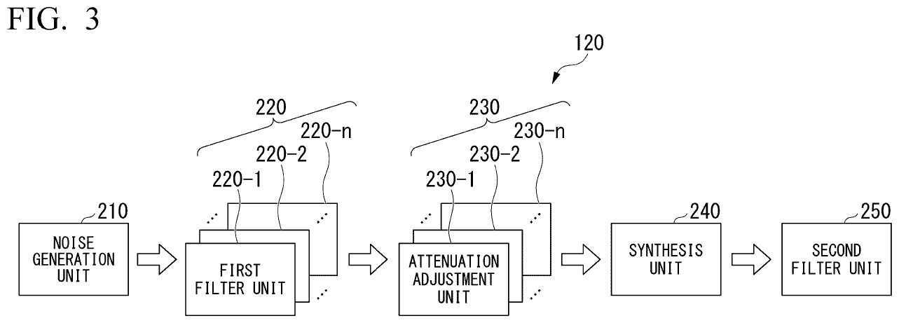

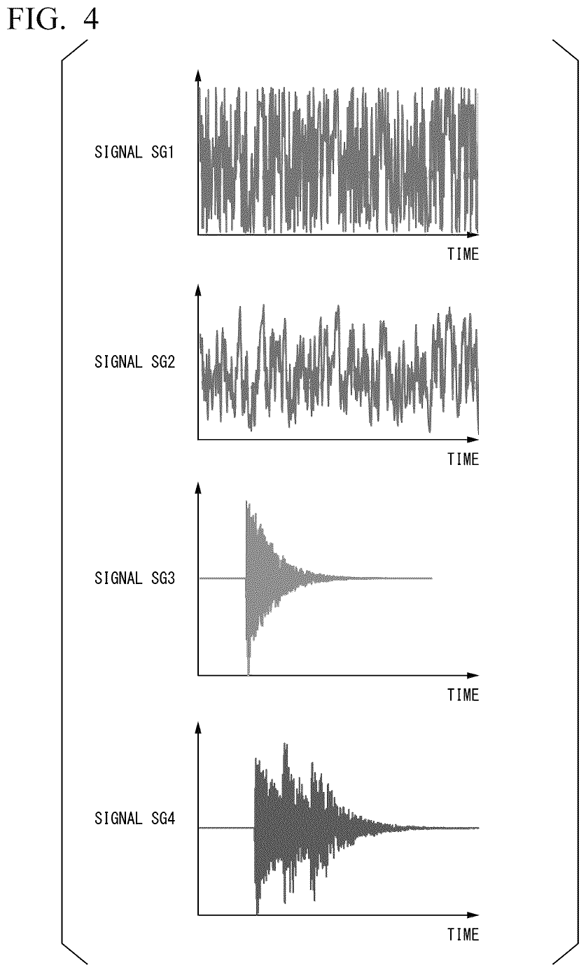

FIG. 3 is a block showing an internal configuration of the generation unit in the first embodiment of the present disclosure. FIG. 4 is a diagram showing an example of a signal waveform generated by the generation unit in the first embodiment of the present disclosure. As shown in FIG. 3, the generation unit 120 includes a noise generation unit 210, a first filter unit 220, an envelope adjustment unit 230, a synthesis unit 240, and a second filter unit 250.

The noise generation unit 210 generates a noise signal. The noise signal generated by the noise generation unit 210 is, for example, a signal including pink or white noise. Furthermore, the noise signal generated by the noise generation unit 210 is not limited to a signal including pink noise or white noise and may include any noise. In FIG. 4, the noise signal generated by the noise generation unit 210 is illustrated as a signal SG1.

The first filter unit 220 includes a plurality of frequency filters 220-1 to 220-n (n is an integer of 2 or more). Each of the frequency filters 220-1 to 220-n is, for example, a bandpass filter that passes a frequency in only a predetermined frequency band. Furthermore, each of the frequency filters 220-1 to 220-n may be a low-pass filter that passes a frequency less than or equal to a predetermined frequency or a high-pass filter that passes a frequency greater than or equal to the predetermined frequency.

The pass frequency bands of the frequency filters 220-1 to 220-n can be set individually. By adjusting the pass frequency bands of the frequency filters 220-1 to 220-n, for example, it is possible to generate vibrations or the like for producing the above-described accelerator response feeling, traction feeling, and speed feeling and the like. In FIG. 4, a signal filtered by any one of the frequency filters 220-1 to 220-n is illustrated as a signal SG2.

The envelope adjustment unit 230 includes a plurality of attenuation adjustment units 230-1 to 230-n. The attenuation adjustment units 230-1 to 230-n are each provided in association with the frequency filters 220-1 to 220-n. The attenuation adjustment units 230-1 to 230-n attenuate signals output from the corresponding frequency filters 220-1 to 220-n. That is, the envelope adjustment unit 230 adjusts the envelope of the signal output from each of the frequency filters 220-1 to 220-n.

An attenuation amount, an attenuation coefficient, and an attenuation method in the attenuation adjustment units 230-1 to 230-n can be set individually. By individually adjusting the attenuation amount in the attenuation adjustment units 230-1 to 230-n, for example, it is possible to generate vibrations or the like for producing the above-described accelerator response feeling, traction feeling, and speed feeling and the like. In FIG. 4, a signal attenuated by any one of the attenuation adjustment units 230-1 to 230-n is illustrated as a signal SG3.

The synthesis unit 240 synthesizes signals output from the attenuation adjustment units 230-1 to 230-n of the envelope adjustment unit 230. For example, the synthesis unit 240 performs a synthesis process by superimposing the signals output from the attenuation adjustment units 230-1 to 230-n. Furthermore, when the synthesis unit 240 synthesizes the signals output from the attenuation adjustment units 230-1 to 230-n output from the attenuation adjustment units 230-1 to 230-n, the intensity of the signal output from each of the attenuation adjustment units 230-1 to 230-n may be adjusted.

The second filter unit 250 performs a process of multiplying the signals synthesized by the synthesis unit 240 by an inverse function of a vibration transfer function of the vehicle M. This process is performed so that the signals synthesized by the synthesis unit 240 are reproduced at a position where the vibrations are reproduced (for example, at positions where the vibration devices VD1 and VD2 are provided or at the predetermined point P). Thereby, a vibration profile is generated.

### <Control of Vibration Devices>

As described above, the control unit 130 vibrates the vibration devices VD1 and VD2 in accordance with the vibration profile generated by the generation unit 120 or the vibration profile 140A stored in the storage unit 140. When the vibration devices VD1 and VD2 are vibrated in accordance with the vibration profile, the control unit 130 performs control so that the vibration intensities of the vibration devices VD1 and VD2 gradually increase or decrease within a prespecified transition period at the start or end of the vibrations. This control is performed to prevent the occurrence of the failure or abnormal noise in the vibration devices VD1 and VD2 by softening the sudden operations of the vibration devices VD1 and VD2.

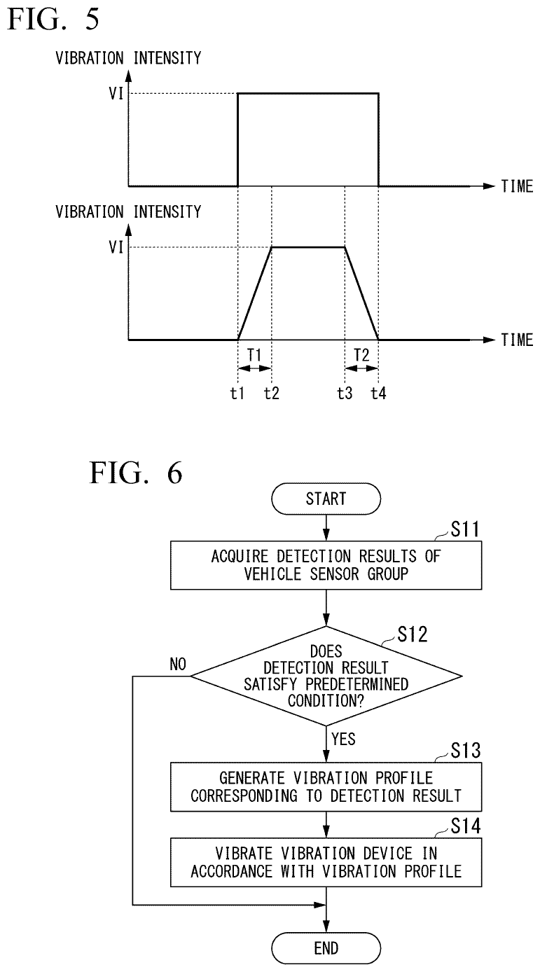

FIG. 5 is an explanatory diagram of the control of a vibration device in the first embodiment of the present disclosure. For example, as shown in the upper graph of FIG. 5, it is assumed that the vibration profile for use in the control unit 130 causes the vibrations having a vibration intensity of VI to start at time t1 and causes the vibrations having the vibration intensity of VI to end at time t4. As shown in the lower graph of FIG. 5, the control unit 130 performs control so that the vibration intensity gradually increases from 0 within a transition period T1 set between times t1 and t2 at the start of the vibrations and the vibration intensity becomes VI at time t2. Moreover, the control unit 130 performs control so that the vibration intensity gradually decreases from VI within a transition period T2 set between times t3 and t4 at the end of the vibrations and the vibration intensity becomes 0 at time t4.

Although an example in which the vibration intensity increases linearly within the transition period T1 and the vibration intensity decreases linearly within the transition period T2 is shown in the example shown in FIG. 5, a method for changing the vibration intensity within the transition periods T1 and T2 is optional. For example, the vibration intensity may be increased or decreased in a curved or exponential manner, and may be increased or decreased step by step. Moreover, the lengths of the transition periods T1 and T2 are set to, for example, about 5 to 10 [ms]. However, the lengths of the transition periods T1 and T2 are not limited to about 5 to 10 [ms], and can be set to any lengths.

### <Control Method>

FIG. 6 is a flowchart showing an example of a control method according to the first embodiment of the present disclosure. Furthermore, the process of the flowchart shown in FIG. 6 is iteratively executed, for example, at regular time intervals. When the process shown in FIG. 6 begins, the acquisition unit 110 of the control device 100 first acquires detection results of the vehicle sensor group 40 (step S11). For example, the acquisition unit 110 acquires detection results of an accelerator position sensor, an acceleration sensor, a vehicle speed sensor, and another sensor provided in the vehicle sensor group 40. Furthermore, the detection results acquired by the acquisition unit 110 are output to the generation unit 120 and the control unit 130.

Subsequently, the control unit 130 of the control device 100 determines whether or not the detection result acquired by the acquisition unit 110 satisfies a predetermined condition (step S12). For example, the control unit 130 determines whether or not at least one of the detection result of the accelerator position sensor, the detection result of the acceleration sensor, and the detection result of the vehicle speed sensor is equal to or greater than a threshold value preset for each detection result.

When the control unit 130 determines that the detection result acquired by the acquisition unit 110 does not satisfy a predetermined condition (when the determination result in step S12 is “NO”), the process of the flowchart shown in FIG. 6 ends. On the other hand, when the control unit 130 determines that the detection result acquired by the acquisition unit 110 satisfies the predetermined condition (when the determination result in step S12 is “YES”), the generation unit 120 generates a vibration profile corresponding to the detection result (step S13).

For example, when the result of the accelerator position sensor is greater than a predetermined threshold value, the generation unit 120 generates a vibration profile that defines vibrations for producing an accelerator response feeling. In this vibration profile, for example, a vibration intensity and a vibration frequency are defined in accordance with the accelerator opening degree and the acceleration of the vehicle M in the longitudinal direction. Moreover, when the detection result of the acceleration sensor is equal to or greater than the threshold value, the generation unit 120 generates a vibration profile that defines vibrations for producing the traction feeling. In this vibration profile, for example, the vibration intensity and vibration frequency are defined according to the acceleration of the vehicle M in the longitudinal direction and the acceleration of the vehicle M in the lateral direction. Alternatively, when the detection result of the vehicle speed sensor is equal to or greater than the threshold value, the generation unit 120 generates a vibration profile that defines vibrations for producing the speed feeling. In this vibration profile, for example, the vibration intensity and vibration frequency are defined in accordance with the vehicle speed of the vehicle M.

Subsequently, the control unit 130 vibrates the vibration devices VD1 and VD2 in accordance with the vibration profile generated by the generation unit 120 (step S14). For example, the control unit 130 vibrates the vibration devices VD1 and VD2 in accordance with a vibration profile that defines vibrations for producing the accelerator response feeling. Thereby, the accelerator response feeling is produced. Moreover, the control unit 130 vibrates the vibration devices VD1 and VD2 in accordance with the vibration profile that defines vibrations for producing the traction feeling. Thereby, the traction feeling is produced. Alternatively, the control unit 130 vibrates the vibration devices VD1 and VD2 in accordance with a vibration profile that defines vibrations for producing the speed feeling. Thereby, the speed feeling is produced.

By performing the above-described process, vibrations corresponding to at least one of the driving situation of the vehicle M and the behavior of the vehicle M are generated in the vibration devices VD1 and VD2. Thereby, it is possible to produce an immersive feeling during driving.

Furthermore, an example in which the generation unit 120 generates a vibration profile (step S13) and the control unit 130 vibrates the vibration devices VD1 and VD2 in accordance with the generated vibration profile (step S14) has been described with reference to FIG. 6. However, the step of selecting the vibration profile 140A corresponding to the detection result and reading the vibration profile 140A from the storage unit 140 may be executed instead of step S13. Thereby, the vibration profile 140A corresponding to the detection result of the vehicle sensor group 40 is selected and read from the storage unit 140 and the vibration devices VD1 and VD2 are vibrated in accordance with the read vibration profile.

### <<Production of Accelerator Response Feeling>>

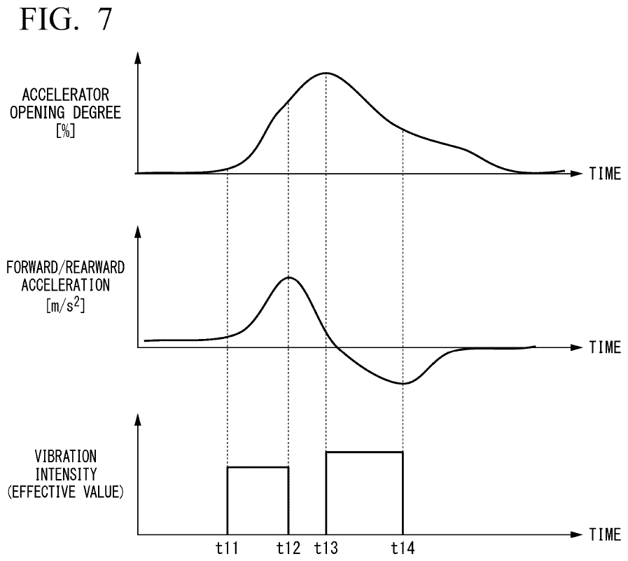

FIG. 7 is an explanatory diagram of an example in which the accelerator response feeling is produced in the first embodiment of the present invention. In FIG. 7, the graph shown in the upper portion is a graph indicating a change in an accelerator opening degree over time, the graph shown in the middle portion is a graph indicating a change in acceleration of the vehicle M over time in the longitudinal direction, and the graph shown in the lower portion is a graph indicating changes in vibration intensities of the vibration devices VD1 and VD2 over time.

In the example shown in FIG. 7, the accelerator response feeling is produced during a period of time t11 to t12 and a period of time t13 to t14. Time t11 is the time when the accelerator opening degree is equal to or greater than a predetermined threshold value and time t12 is the time when a magnitude of acceleration (positive acceleration) of the vehicle M in the forward direction is maximized. Moreover, time t13 is the time when the accelerator opening degree is maximized and time t14 is the time when a magnitude of acceleration (negative acceleration) of the vehicle M in the rearward direction is maximized.

That is, during the period of time t11 to t12, the driver of the vehicle M gradually increases the depression of the accelerator pedal and the vehicle M gradually accelerates. Moreover, during the period of time t13 to t14, the driver of the vehicle M gradually relaxes the depression of the accelerator pedal and the vehicle M gradually decelerates. For example, in the period of time t11 to t12, the vibration devices VD1 and VD2 are vibrated with vibration intensities and vibration frequencies lower than in the period of time t13 to t14, and in the period of time t13 to t14, the vibration devices VD1 and VD2 are vibrated with vibration intensities and vibration frequencies higher than in the period of time t11 to t12.

Here, the vibration intensities and vibration frequencies of the vibration devices VD1 and VD2 may be changed with a magnitude of acceleration. For example, in the period of time t11 to t12, the vibration devices VD1 and VD2 may be vibrated so that the vibration intensity and vibration frequency gradually increase (for example, linearly) as the magnitude of acceleration increases. Alternatively, in the period of time t13 to t14, the vibration devices VD1 and VD2 may be vibrated so that the vibration intensity and vibration frequency gradually decrease (for example, linearly) as the magnitude of acceleration increases.

As described above, the vibration devices VD1 and VD2 are vibrated to reproduce the accelerator response feeling. That is, the driver of the vehicle M can feel an acceleration feeling when the vehicle M accelerates if the accelerator pedal is depressed and can feel a deceleration feeling when the vehicle M decelerates if the depression of the accelerator pedal is relaxed.

### <<Production of Traction Feeling>>

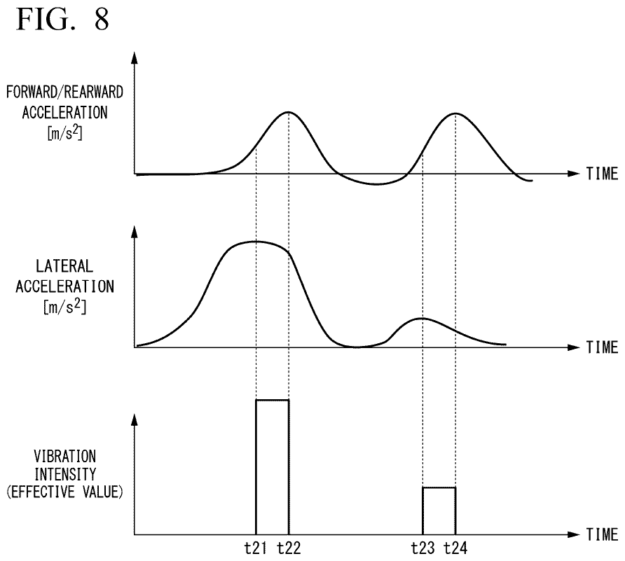

FIG. 8 is an explanatory diagram of an example in which the traction feeling is produced in the first embodiment of the present invention. In FIG. 8, the graph shown in the upper portion is a graph indicating a change in acceleration of the vehicle M over time in the longitudinal direction, the graph shown in the middle portion is a graph indicating a change in acceleration of the vehicle M over time in the lateral direction, and the graph shown in the lower portion is a graph indicating changes in vibration intensities of the vibration devices VD1 and VD2 over time.

In the example shown in FIG. 8, the traction feeling is produced during the period of time t21 to t22 and the period of time t23 to t24. Time t21 is the time when magnitudes of acceleration of the vehicle M in the forward direction and the lateral direction are equal to or greater than a predetermined threshold value and time t22 is the time when the magnitude of the acceleration of the vehicle M in the forward direction is maximized. Likewise, time t23 is the time when the magnitudes of the acceleration of the vehicle M in the forward direction and the lateral direction are equal to or greater than the predetermined threshold value and time t24 is the time when the magnitude of the acceleration of the vehicle M in the forward direction is maximized.

That is, the period of time t21 to t22 and the period of time t23 to t24 correspond to a situation in which the acceleration of the vehicle M in the forward direction gradually increases and the vehicle M accelerates in the lateral direction (for example, a situation in which the vehicle M is turning). Furthermore, in the example shown in FIG. 8, in the period of time t21 to t22, the acceleration of the vehicle M in the lateral direction is greater than in the period of time t23 to t24.

For example, during the period of time t21 to t22 and the period of time t23 to t24, the vibration devices VD1 and VD2 are vibrated with similar vibration frequencies. Furthermore, the vibration frequencies of the vibration devices VD1 and VD2 are preferably lower than the vibration frequency for a case where the accelerator response feeling is reproduced to reproduce the traction feeling. In the period of time t21 to t22, the acceleration of the vehicle M in the lateral direction is greater than in the period of time t23 to t24. For this reason, in the period of time t21 to t22, the vibration devices VD1 and VD2 are vibrated with a vibration intensity greater than in the period of time t23 to t24.

Here, the vibration intensities and vibration frequencies of the vibration devices VD1 and VD2 may be changed with the magnitude of acceleration. For example, in the period of time t21 to t22 and the period of time t23 to t24, because the acceleration of the vehicle M in the forward direction is gradually increasing, the vibration devices VD1 and VD2 may be vibrated so that the vibration intensity and vibration frequency gradually increase (for example, linearly) as the magnitude of the acceleration increases.

As described above, the vibration devices VD1 and VD2 are vibrated to reproduce the traction feeling. That is, for example, when the driver of the vehicle M manipulates the steering wheel SW while the accelerator pedal is depressed, the driver can feel the traction feeling due to the grip force of the tire when the vehicle M turns.

### <<Production of Speed Feeling>>

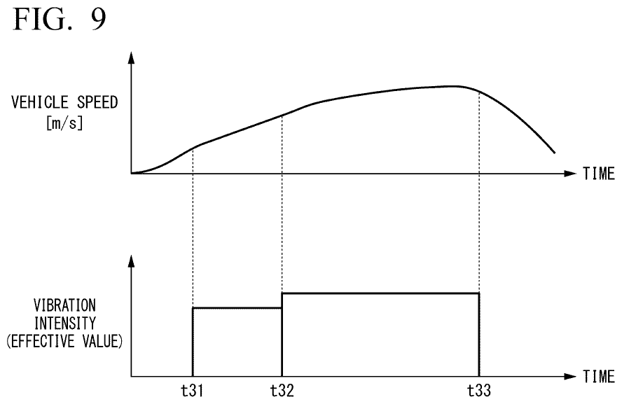

FIG. 9 is an explanatory diagram of an example in which the speed feeling is produced in the first embodiment of the present invention. In FIG. 9, the graph shown in the upper portion is a graph indicating a change in the vehicle speed of the vehicle M over time and the graph shown in the lower portion is a graph indicating changes in the vibration intensities of the vibration devices VD1 and VD2 over time.

In the example shown in FIG. 9, the speed feeling is produced in the period of time t31 to t32 and the period of time t32 to t33. For example, the period of time t31 to t32 is a period for a case where the vehicle M is moving on a general road and the period of time t32 to t33 is a period for a case where the vehicle M is moving on a highway.

For example, during the period of time t31 to t32 and the period of time t32 to t33, the vibration devices VD1 and VD2 are vibrated with similar vibration frequencies. Furthermore, the vibration frequencies of the vibration devices VD1 and VD2 are preferably equal to or lower than a vibration frequency for a case where the accelerator response feeling is reproduced to reproduce the speed feeling and higher than a vibration frequency for a case where the traction feeling is reproduced. In the period of time t32 to t33, the vehicle speed of the vehicle M is higher than in the period of time t31 to t32. For this reason, in the period of time t32 to t33, the vibration devices VD1 and VD2 are vibrated with vibration intensities greater than in the period of time t31 to t32.

Here, the vibration intensities and vibration frequencies of the vibration devices VD1 and VD2 may be changed with the magnitude of the vehicle speed. For example, because the vehicle speed of the vehicle M is gradually increasing in both the period of time t31 to t32 and the period of time t32 to t33, the vibration devices VD1 and VD2 may be vibrated so that the vibration intensity and vibration frequency gradually increase (for example, linearly) as the vehicle speed increases.

As described above, the vibration devices VD1 and VD2 are vibrated to reproduce the speed feeling. That is, the driver of the vehicle M, for example, can feel the speed feeling corresponding to the vehicle speed of the vehicle M.

As described above, in the present embodiment, the acquisition unit 110 acquires the detection results of the vehicle sensor group 40 that detects at least one of the driving situation of the vehicle M and the behavior of the vehicle M. Also, according to the detection results acquired by the acquisition unit 110, the control unit 130 causes the vibration devices VD1 and VD2 to generate vibrations corresponding to at least one of the driving situation of the vehicle M and the behavior of the vehicle M. Thereby, for example, because it is possible to reproduce the accelerator response feeling, the traction feeling, and the speed feeling, the immersive feeling during driving can be produced.

### Second Embodiment

### <Control Device>

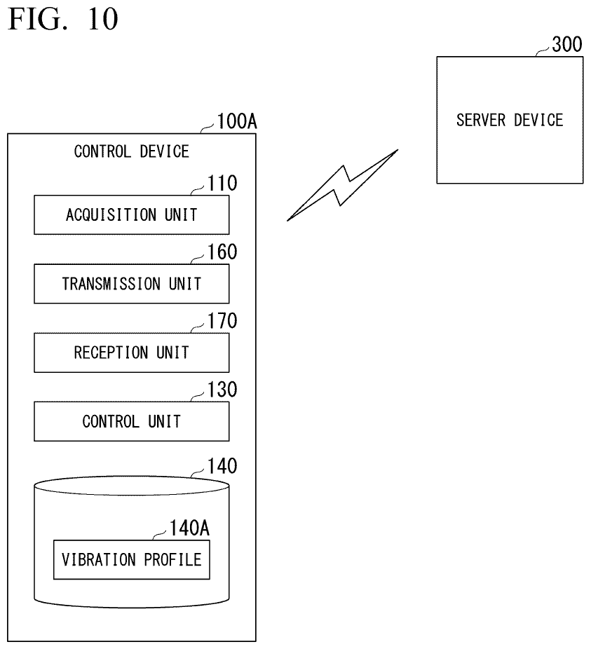

FIG. 10 is a block diagram showing a key configuration of a control device according to a second embodiment of the present disclosure. Furthermore, like the control device 100 shown in FIG. 2, a control device 100A of the present embodiment is mounted on the vehicle and causes vibration devices VD1 and VD2 to generate vibrations on a steering wheel SW.

As shown in FIG. 10, the control device 100A of the present embodiment has a configuration of a transmission unit 160 and a reception unit 170 instead of the generation unit 120 of the control device 100 shown in FIG. 2. The control device 100 of the first embodiment uses the vibration profile 140A stored in the storage unit 140 or the vibration profile generated by the generation unit 120. On the other hand, the control device 100A of the present embodiment uses a vibration profile transmitted from a server device 300.

The transmission unit 160 and the reception unit 170 are wirelessly connected to the server device 300. For example, the transmission unit 160, the reception unit 170, and the server device 300 are wirelessly connected through 4G (a fourth-generation mobile communication system) or 5G (a fifth-generation mobile communication system). Connection forms between the transmission unit 160 and the reception unit 170 and the server device 300 are not limited to 4G or 5G and may be any connection forms. In the transmission unit 160 and the reception unit 170, information indicating the address of the server device 300 is preset. The transmission unit 160 and the reception unit 170 can communicate with the server device 300 by identifying the server device 300 through an address.

The transmission unit 160 transmits detection results of a vehicle sensor group 40 acquired by an acquisition unit 110 to the server device 300. For example, in step S12 of FIG. 6, the transmission unit 160 may transmit only a detection result of a control unit 130 determining that a predetermined condition is satisfied to the server device 300. The reception unit 170 receives the vibration profile transmitted from the server device 300 as a reply to the detection result transmitted by the transmission unit 160. The reception unit 170 outputs the received vibration profile to the control unit 130. Furthermore, the vibration profile received by the reception unit 170 may be stored in a storage unit 140.

The server device 300 transmits a vibration profile corresponding to the detection result transmitted from the control device 100A to the control device 100A. For example, the server device 300 includes a part similar to the generation unit 120 described with reference to FIG. 3 and a vibration profile corresponding to the detection result transmitted from the control device 100A may be generated by the method described with reference to FIGS. 3 and 4. Furthermore, the method by which the server device 300 generates the vibration profile is not limited to the method described with reference to FIGS. 3 and 4 and may be another method.

Alternatively, the server device 300 may store a wide variety of vibration profiles in advance, read the vibration profile corresponding to the detection result transmitted from the control device 100A, and transmit the read vibration profile to the control device 100A. Because the server device 300 can include a storage unit having a larger capacity than the storage unit 140 mounted on the vehicle M, a wide variety of vibration profiles can be stored.

### <Control Method>

The control method of the present embodiment is similar to that of the first embodiment, except that the vibration profile transmitted from the server device 300 is used. That is, in the control method according to the second embodiment of the present disclosure, for example, “generating a vibration profile corresponding to the detection result” in step S13 shown in FIG. 6 is replaced with “transmitting the detection result to the server device and receiving the vibration profile transmitted from the server device.” Hereinafter, the control method of the second embodiment will be described with reference to FIG. 6 whose part of the control method is replaced.

In the present embodiment, when the process begins, the acquisition unit 110 of the control device 100 acquires a detection result of the vehicle sensor group 40 as in the first embodiment (step S11). Subsequently, the control unit 130 of the control device 100 determines whether or not the detection result acquired by the acquisition unit 110 satisfies a predetermined condition (step S12). When the control unit 130 determines that the detection result acquired by the acquisition unit 110 does not satisfy the predetermined condition (when the determination result in step S12 is “NO”), the process of the flowchart shown in FIG. 6 ends.

On the other hand, when the control unit 130 determines that the detection result acquired by the acquisition unit 110 satisfies the predetermined condition (when the determination result in step S12 is “YES”), the transmission unit 160 transmits a detection result indicating that the predetermined condition is satisfied to the server device 300. Also, the reception unit 170 receives the vibration profile transmitted from the server device 300 as a reply to the detection result transmitted by the transmission unit 160 (step S13 of the replacement).

Subsequently, the control unit 130 vibrates vibration devices VD1 and VD2 in accordance with the vibration profile generated by the generation unit 120 (step S14). For example, the control unit 130 vibrates the vibration devices VD1 and VD2 in accordance with a vibration profile that defines vibrations for producing an accelerator response feeling. Thereby, the accelerator response feeling is produced. Moreover, the control unit 130 vibrates the vibration devices VD1 and VD2 in accordance with a vibration profile that defines vibrations for producing a traction feeling. Thereby, the traction feeling is produced. Alternatively, the control unit 130 vibrates the vibration devices VD1 and VD2 in accordance with a vibration profile that defines vibrations for producing a speed feeling. Thereby, the speed feeling is produced.

By performing the process described above, vibrations corresponding to at least one of the driving situation of the vehicle M and the behavior of the vehicle M are generated in the vibration devices VD1 and VD2. Thereby, for example, because the accelerator response feeling, the traction feeling, and the speed feeling are reproduced, an immersive feeling during driving can be produced.

As described above, in the present embodiment, the acquisition unit 110 acquires a detection result of the vehicle sensor group 40 that detects at least one of the driving situation of the vehicle M and the behavior of the vehicle M. Also, the control unit 130 causes the vibration devices VD1 and VD2 to generates vibrations corresponding to at least one of the driving situation of the vehicle M and the behavior of the vehicle M in accordance with the detection result acquired by the acquisition unit 110. Thereby, for example, because the accelerator response feeling, the traction feeling, and the speed feeling are reproduced, the immersive feeling during driving can be produced.

Although the control device, the control method, and the recording medium according to the embodiments of the present disclosure have been described above, the present disclosure is not limited to the above-described embodiments and can be freely changed within the scope of the present disclosure. For example, the server device 300 described in the above-described second embodiment may be implemented in a cloud computing system.

Moreover, when the vibration devices VD1 and VD2 are vibrated, vibrations in an audible range may be superimposed on the original vibrations. Alternatively, the vibrations in the audible range are emitted from a speaker in synchronization with the vibrations of the vibration devices VD1 and VD2. Thereby, hearing is reproduced in addition to a feeling, such that it is possible to better reproduce a texture during driving.

Moreover, in the above-described second embodiment, as in the first embodiment, when the vibration devices VD1 and VD2 are vibrated in accordance with the vibration profile, the control unit 130 performs control so that the vibration intensities of the vibration devices VD1 and VD2 gradually increase or decrease within a prespecified transition period at the start or end of the vibrations. Thereby, in the second embodiment, it is also possible to prevent the occurrence of the failure or abnormal noise in the vibration devices VD1 and VD2 by softening the sudden operations of the vibration devices VD1 and VD2.

Moreover, in the above-described first and second embodiments, the vibration devices VD1 and VD2 may be ended when a certain period of time has elapsed from the start of the vibrations of the vibration devices VD1 and VD2 so that the hassle of driving due to continuous vibrations is avoided. Moreover, an example in which the traction feeling is produced on the basis of acceleration of the vehicle M in the longitudinal direction and the lateral directions has been described in the above-described embodiment. However, the traction feeling may be produced on the basis of only the acceleration of the vehicle M in the longitudinal direction or on the basis of only the acceleration of the vehicle M in the lateral direction.

What is claimed is:

1. A control device for controlling vibrations generated by a vibration device mounted on a driving manipulation element of a vehicle, the control device comprising:
a processor,
wherein the processor executes a program to acquire a detection result of a detection sensor that detects at least one of a driving situation of the vehicle and behavior of the vehicle, and
cause the vibration device to generate vibrations corresponding to at least one of the driving situation of the vehicle and the behavior of the vehicle in accordance with the acquired detection result.

2. The control device according to claim 1, wherein the processor generates the vibrations corresponding to at least one of the driving situation of the vehicle and the behavior of the vehicle on the basis of the acquired detection result.

3. The control device according to claim 1, wherein the processor
selects definition information for defining the vibrations corresponding to at least one of the driving situation of the vehicle and the behavior of the vehicle from definition information for defining a plurality of vibrations provided in advance on the basis of the acquired detection result, and
causes the vibration device to generate the vibrations based on the selected definition information.

4. The control device according to claim 1, wherein the processor
transmits the acquired detection result to a server device,
receives definition information for defining the vibrations corresponding to at least one of the driving situation of the vehicle and the behavior of the vehicle transmitted from the server device in accordance with the detection result transmitted to the server device, and
causes the vibration device to generate the vibrations based on the received definition information.

5. The control device according to claim 1, wherein the processor performs control so that a vibration intensity of the vibration device gradually increases or decreases within a prespecified transition period at a start or end of the vibrations of the vibration device.

6. The control device according to claim 1, wherein the processor
acquires a detection result of a detection sensor that detects an accelerator opening degree of the vehicle, and
causes the vibration device to generate the vibrations corresponding to a manipulation situation of an accelerator pedal on the basis of the acquired detection result.

7. The control device according to claim 1, wherein the processor
acquires a detection result of a detection sensor that detects at least one of acceleration of the vehicle in a longitudinal direction and acceleration of the vehicle in a lateral direction, and
causes the vibration device to generate the vibrations corresponding to the behavior of the vehicle on the basis of the acquired detection result.

8. The control device according to claim 1, wherein the processor
acquires a detection result of a detection sensor that detects a speed of the vehicle, and
causes the vibration device to generate the vibrations corresponding to the speed of the vehicle on the basis of the acquired detection result.

9. A control method for controlling vibrations generated by a vibration device mounted on a driving manipulation element of a vehicle, the control method comprising:
acquiring, by a computer, a detection result of a detection sensor that detects at least one of a driving situation of the vehicle and behavior of the vehicle, and
causing, by the computer, the vibration device to generate vibrations corresponding to at least one of the driving situation of the vehicle and the behavior of the vehicle in accordance with the acquired detection result.

10. A computer-readable non-transitory recording medium recording a program for causing a computer to
acquire a detection result of a detection sensor that detects at least one of a driving situation of a vehicle and behavior of the vehicle, and
cause a vibration device mounted on a driving manipulation element of the vehicle to generate vibrations corresponding to at least one of the driving situation of the vehicle and the behavior of the vehicle in accordance with the acquired detection result.
